(19) United States
(12) Patent Application Publication
(10) Pub. No.: US 2016/0214795 A1
(43) Pub. Date: Jul. 28, 2016

(54) HORIZONTAL ADAPTABLE BRACKET ASSEMBLY FOR PALLET RACKS

(71) Applicant: ROBERT CONSAUL, SAN CARLAS, CA (US)

(72) Inventor: ROBERT CONSAUL, SAN CARLAS, CA (US)

(21) Appl. No.: 14/606,249

(22) Filed: Jan. 27, 2015

(51) Int. Cl. B65G 1/02; F16M 13/02

(52) U.S. Cl. CPC B65G 1/02; F16M 13/02

(57) ABSTRACT

The general purpose of the new horizontal adaptable bracket assembly is to provide a pallet rack load stop system wherein a novel bracket combines with existing beams to easily create a load stop for use on all storage levels of pallet racks. The primary benefit of the new horizontal bracket is that it prevents goods stored on pallets from infringing on government-mandated flue space and other regulations related to large-scale storage of product, such as in warehouses.

### FEDERALLY-SPONSORED RESEARCH

Not Applicable.

### SEQUENCE LISTING

Not applicable.

### BACKGROUND OF THE INVENTION

The general purpose of the new horizontal adaptable bracket assembly is to provide a pallet rack load stop system wherein a novel bracket combines with existing beams to easily create a load stop for use on all storage levels of pallet racks. The primary benefit of the new horizontal bracket is that it prevents goods stored on pallets from infringing on government-mandated flue space and other regulations related to large-scale storage of product, such as in warehouses. The current invention improves on previous products in that it enables easy and inexpensive creation of pallet rack load stops for product on storage pallets to facilitate compliance with fire codes.

### SUMMARY OF THE INVENTION

The general purpose of the new bracket assembly is to provide a simple, yet versatile and adaptable mechanism for restricting the distance between loaded pallets. In general, the new horizontal bracket assembly secures at one end to an existing vertical pallet rack beam via bolting the sides of the bracket to the sides of the vertical beam. The bracket has a series of bolt holes on its sides, enabling adjustment of the distance at which the bracket extends beyond on the vertical beam. At the other end, the new bracket assembly connects perpendicularly to one or two strut channels. By attaching two bracket assemblies, one each at opposing ends of the one or two strut channels, a load stop is created whereby the product stored on a pallet rack is restricted from moving beyond the strut channel(s).

By attaching perpendicularly to existing upright beams, the new horizontal bracket serves to prevent overhanging pallets, including goods stored thereon, from being positioned too close to one another. Many government fire codes require a minimum of six (6) inches of clearance between pallets of product and the nearest storage house wall for fire sprinkler effectiveness. The same is true for pallets of product on racks that are situated back-to-back. Likewise, there must be six inches of clearance between pallets of product on horizontally adjacent rows. One horizontal load stop bracket, for example, can be used to protect and maintain longitudinal flue space on both sides of pallet racks that are set back-to-back by preventing overhanging pallets and product from being positioned closer than six inches from one another.

The sum of these advantages unify with the novel device for ensuring adequate spacing between pallets and between pallets of product in a storage house, resulting in an invention that is not anticipated, rendered obvious, suggested, or even implied by any of the prior art support, either alone or in any combination thereof.

These, together with other objects of the invention, along with the various features of novelty characterizing the invention, are described with particularity in the claims herewith. A more comprehensive understanding of the features, operation and uses of the invention may be gleaned from reference to the enclosed drawings and descriptive matter further illustrating the preferred embodiments of the invention.

The embodiments described herein are illustrative of the invention, and it is to be understood that the invention is not limited in its application to the details of construction and to the arrangements of the components set forth in the following description and drawings. The invention is capable of other embodiments and of being practiced and carried out in various ways. It should be further understood that the phraseology and terminology applied herein merely serve the purpose of description and should not be regarded as limiting.

### DESCRIPTION OF THE DRAWING(S)

FIG. 1 illustrates one embodiment of the new horizontal bracket assembly as attached to a vertical beam and a single strut channel.

FIG. 2 illustrates the new horizontal bracket assembly as attached to a vertical beam and two strut channels.

FIGS. 3A-E illustrates the various views of one embodiment of the new bracket assembly.

### DETAILED DESCRIPTION OF THE INVENTION

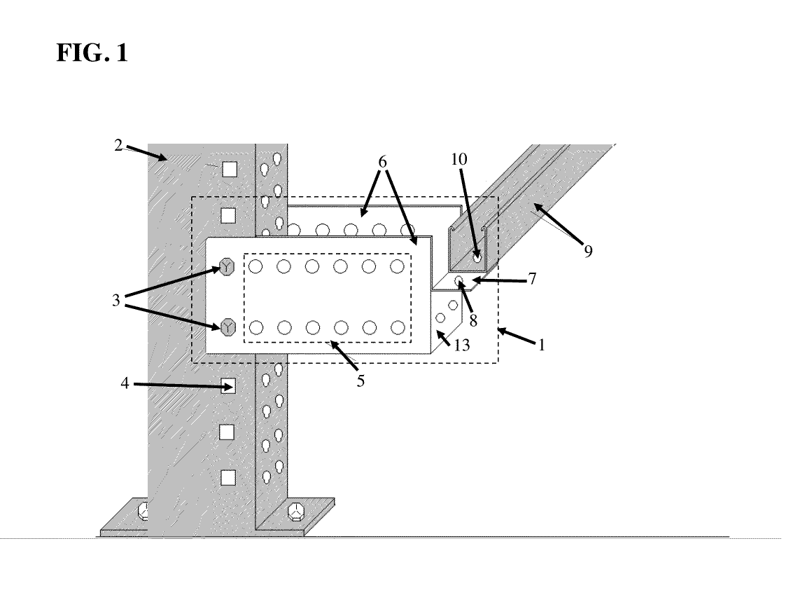

FIG. 1 illustrates one embodiment of the new bracket assembly as attached to a vertical beam and a single horizontal strut beam. The new bracket assembly, as depicted, is used on a pallet rack up against a wall or abutting another pallet rack to protect items and maintain required space between pallets and a wall or other pallets of product for government heath, food safety and fire code requirements.

A horizontal bracket assembly 1 attaches via an interlocking end to an upper horizontal load stop beam 2 via insertion of two bolts 3 through two vertically adjacent holes in one side 6 of the bracket 1, through the complementary holes on both sides of the vertical beam 2, and finally through the complementary holes on the other side 6 of the horizontal bracket 1. As there are bolt holes 4 along the length of a vertical beam 2, the horizontal bracket 1 can be positioned at the appropriate height and can be adjusted as desired.

The horizontal bracket assembly 1 further attaches via a securing end 7 to a horizontal strut channel 9 via one or two standard bolts 10 that secure the channel 9 and securing end 7 by bolting through complimentary holes in each part. The securing end 7 has two bolt holes 8 enabling attachment of either one or two strut channels 9.

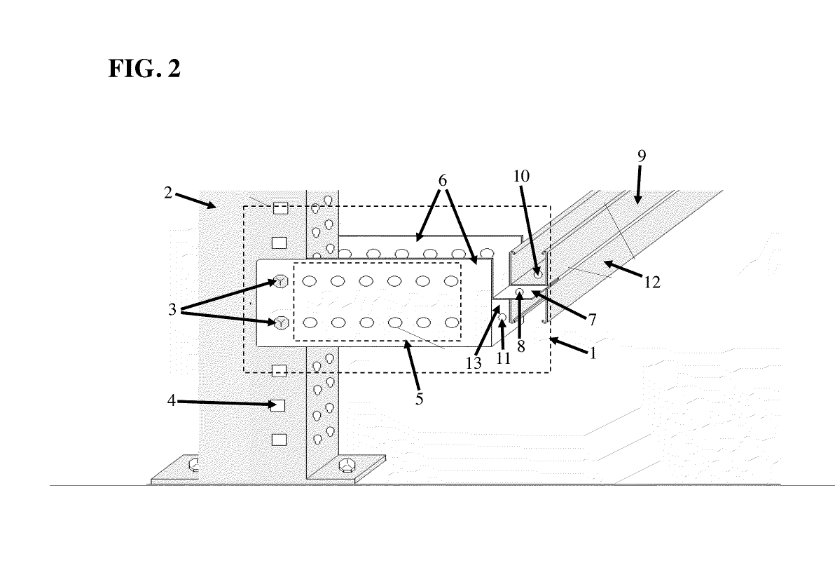

FIG. 2 illustrates the new horizontal bracket assembly 1 as attached to a vertical beam 2 and two strut channels 9, 12. As shown in FIG. 1, a first strut channel 9 is secured to the securing end 7 by bolting through complimentary holes in each part. FIG. 2 shows a second strut channel 12 secured to the other side of the securing end 7 using the same bolt securing the first strut channel 9 to the securing end 7. FIG. 2 also shows additional holes 11 on the vertical plate 13 of the securing end, which can be used to secure a strut rotated 90-degrees.

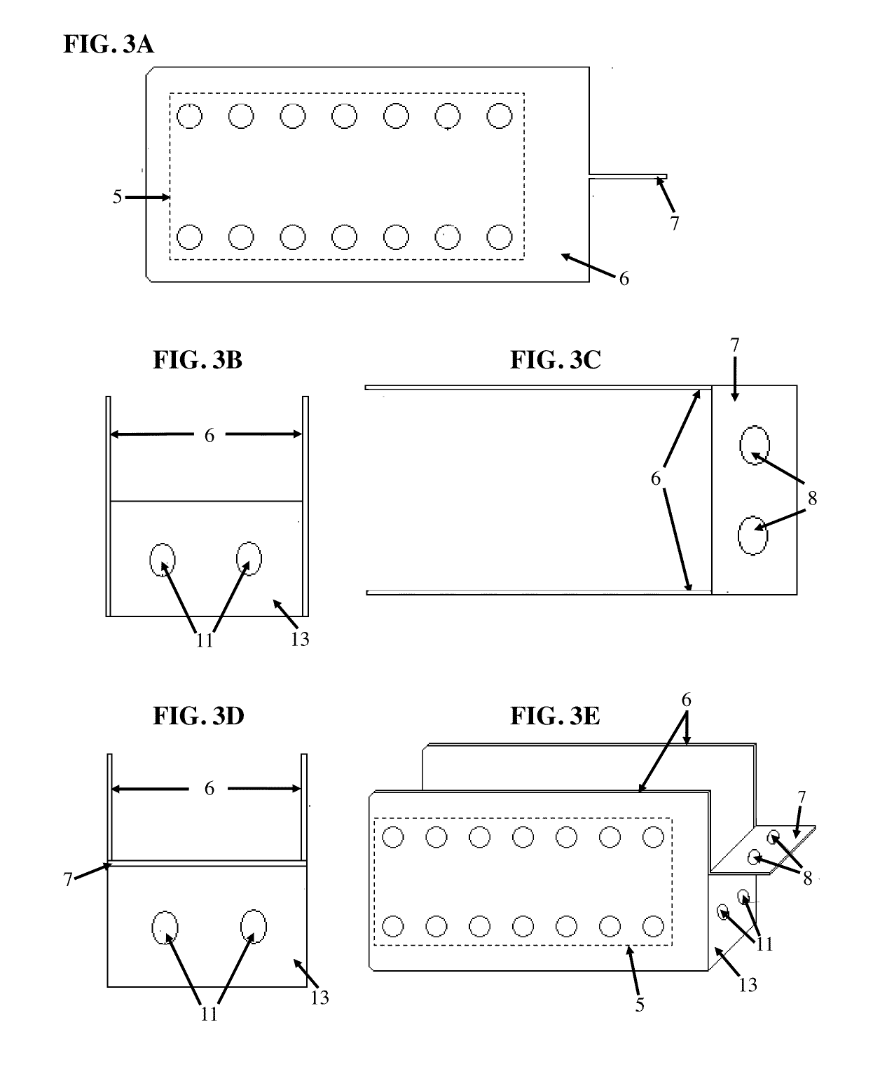

FIGS. 3A-E illustrates the various views of one embodiment of the new bracket assembly. FIG. 3A shows the side view of the bracket consisting of a plate 6 with fourteen holes 5, and a perpendicular end plate 7. FIG. 3B shows the front end view of the horizontal bracket assembly having two parallel sides 6, an end plate 13 and two bolt holes 11. FIG. 3C shows the top view of the horizontal bracket assembly having two parallel sides 6, a perpendicular end plate 7 and two bolt holes 8 in the perpendicular endplate. FIG. 3D shows the back end of the horizontal bracket assembly with two parallel sides 6, an end plate 13 with two bolt holes 11, and a perpendicular end plate 7. FIG. 3E shows a perspective view of the horizontal bracket having two parallel sides 6 with fourteen bolt holes 5 in each of the parallel sides, an end plate 13 with two bolt holes 11, and a perpendicular end plate 7 with two bolt holes 8.

As to further discussion of the manner of usage and operation of the present invention, the same should be apparent from the above description. With respect to the above description then, it is to be realized that the optimum dimensional relationships for the parts of this invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention, the use of which results in a horizontal adaptable bracket assembly for pallet racks.

Although the description presented heretofore contains specificities for the benefit of illustration, these should not be construed as limiting the scope of the embodiments but rather as illustrative examples of some of the several embodiments. Thus, the scope of the embodiments should be determined by the appended claims and their legal equivalents rather than by the examples provided.

What is claimed is:

1. An adaptable bracket assembly for facilitating storehouse flue space, comprising:
a first end unit for attachment to a vertical pallet rack beam, said first end unit having two parallel sides positioned at least 3 inches relative to one another, each side being a plate and each said plate having a plurality of holes complimentary to those of the opposing plate, said holes being large enough to accommodate ⅜-inch bolts; and
a second end unit for attachment to one or more horizontal strut channels, said second end unit having a first plate perpendicular to and connecting the two sides of the first end unit and a second plate attached along one horizontal edge perpendicularly to a horizontal edge of the first plate, said second plate having at least one hole positioned along its vertical axis, said hole(s) being large enough to accommodate a ⅜-inch bolt.

2. The adaptable bracket assembly of claim 1 wherein the inner diameter between the parallel sides of the first end is three inches and the outer diameter is approximately three and one-eighth inches.

3. The adaptable bracket assembly of claim 1 wherein the width of the first plate is three and one-eighth inches and the width of the second plate is three and one-eighth inches.

4. The adaptable bracket assembly of claim 1 wherein the width of the two parallel sides is three and one-half inches and the length of the parallel sides is eleven and one-fourth inches.

5. The adaptable bracket assembly of claim 1 wherein each of the plurality of complementary holes is positioned with its center three-fourths of an inch from the nearest longitudinal edge of the parallel side and one inch from the center of the nearest neighboring hole.

6. The adaptable bracket assembly of claim 1 wherein the plurality of complementary holes is equal to fourteen holes on each of the parallel plates.
